(19) United States
(12) Patent Application Publication
(10) Pub. No.: US 2013/0018153 A1
(43) Pub. Date: Jan. 17, 2013

(54) POLYCHLOROPRENE COMPOSITIONS WITH IMPROVED ADHESION PROPERTIES

(71) Applicant: LANCE ALAN CHRISTELL, LEBANON, TN (US)

(72) Inventor: LANCE ALAN CHRISTELL, LEBANON, TN (US)

(73) Assignee: E I DU PONT DE NEMOURS AND COMPANY, Wilmington, DE (US)

(21) Appl. No.: 13/545,429

(22) Filed: Jul. 10, 2012

Related U.S. Application Data
(60) Provisional application No. 61/506,420, filed on Jul. 11, 2011.

(51) Int. Cl. C09J 147/00

(52) U.S. Cl. 525/190

(57) ABSTRACT

Polymer blend compositions comprising a polychloroprene and 0.1-1.6 wt. % an ethylene acrylic acid copolymer or ethylene methacrylic acid copolymer or their ionomers are provided, the weight percentage being based on the total weight of the polychloroprene and ethylene acrylic acid copolymer, ethylene methacrylic acid copolymer or ionomer in the blend. A process for forming a self-supporting film or sheet of the blend compositions is also disclosed. The compositions have enhanced adhesion to metal.

### CROSS REFERENCE TO RELATED APPLICATION

This application claims priority from U.S. patent application Ser. No. 61/506,420, filed on Jul. 11, 2011, which is incorporated herein by reference in its entirety.

### FIELD OF THE INVENTION

The present invention is directed to a process for the production of a polymer composition comprising a polychloroprene and either an ethylene carboxylic acid copolymer or an ionomer of an ethylene carboxylic acid copolymer, and to an adhesive composition that exhibits excellent metal adhesion properties.

### BACKGROUND OF THE INVENTION

Cured polymers of 2-chloro-1,3-butadiene (chloroprene) are well-known elastomeric materials useful in a wide variety of products, including adhesive compositions and molded goods. Improved adhesion to substrates and high temperature resistance are desirable properties in both applications. With respect to adhesives, high temperature resistance permits usage in a broadened range of household and industrial applications. With respect to molded goods, improved adhesion permits use more effectively in high temperature environments, especially in instances wherein a rubber composition is molded to a metal insert, such as in engine compartments where metal parts are subjected to high temperatures.

Polychloroprene solvent-based adhesives are commercially available products that are capable of bonding to many types of substrates. Adhesive bond strengths are high and chemical resistance is excellent. Despite their superior bonding properties, the use of solvent-based adhesives has declined due to environmental and health concerns related to the presence of substantial quantities of volatile organic solvents in such adhesive formulations. As a consequence, the adhesives industry has endeavored to develop alternative polychloroprene compositions that exhibit physical properties equivalent to those of the solvent-based adhesives but which contain lower solvent levels.

Such compositions are described for example in U.S. Pat. No. 3,728,316; U.S. Pat. No. 3,920,600; U.S. Pat. No. 5,332,771; and U.S. Pat. No. RE 36,618. In addition, aqueous adhesives that contain blends of chloroprene polymers are known, for example as disclosed in U.S. Pat. No. 5,407,993. Still, in many instances, aqueous adhesives cannot match the properties of solvent-based adhesives.

Certain chloroprene copolymer solvent-based adhesives that contain methacrylic acid as a comonomer have been used in solvent-based adhesive applications and exhibit excellent high temperature resistance properties and bond strengths. However, preparation of these adhesives can present challenges. For example, preparation of compositions based on copolymers of chloroprene and methacrylic acid, such as those described in U.S. Pat. No. 3,912,676, is expensive and complicated. The manufacturing process involves emulsion polymerization under acidic conditions followed by a stripping step to remove unreacted monomer wherein the pH of the polymer latex is increased to 10.5 or more. The resultant latex is then re-acidified to a pH of 5.5 prior to isolation of the copolymer.

Aqueous dispersions of blends of polychloroprene with salts of high molecular weight polyacrylic acids are also known, for example from Japanese Published Patent Application 60-235874. Such polymer blend compositions can be used as carpet adhesives but they are not suitable for preparation of the uncured solid polychloroprene compositions desirable for manufacture of solvent adhesives. This is because production of such solid grades of polychloroprene on a commercial scale is generally conducted by an aqueous polymerization process wherein a polychloroprene latex is formed that is subsequently coagulated to form a solid polymer film or sheet on a freeze roll. The addition of the particular class of polyacid salts described in Japanese Published Patent Application 60-235874 to an uncoagulated polychloroprene latex creates difficulties in polymer isolation because a self-supporting film cannot be formed from the polychloroprene latex/polyacid salt blend on a freeze roll. Thus, the compositions disclosed in Japanese Published Patent Application 60-235874 are not suitable for commercial scale preparation of polychloroprene compositions or the solvent-based adhesives containing them.

Aqueous adhesive dispersions of polymers, including polychloroprene, and ethylene/ester copolymers, ethylene/acid copolymers and ethylene/acid copolymer ionomers are disclosed in U.S. Pat. No. 3,770,572. Such dispersions are prepared by mixing an aqueous dispersion of the polymers for use in a water-borne adhesive. The ethylene/acid copolymers are present at 20-90 weight percent in the mixture. It is also known to blend polychloroprenes of moderate crystallinity that contain moderate levels of gelled polychloroprene with certain types of carboxylated acrylic resins to prepare aqueous adhesive compositions, for example as disclosed in U.S. Patent Application Publication 2008/0128083. In addition, aqueous contact adhesives are disclosed that contain polychloroprene and a thickening agent that may be an ethylene/carboxylated acrylate polymer, as disclosed in U.S. Pat. No. 6,440,259. These polychloroprene blend compositions would also be incapable of forming a self-supporting film on a freeze roll.

Molded goods that comprise blends of polychloroprenes and ethylene/acid copolymers are disclosed in U.S. Pat. No. 5,140,072, which describes cured blends of polychloroprene and 2-25 wt. % ethylene alpha, beta-unsaturated carboxylic acid copolymers. In addition, U.S. Pat. No. 4,307,204 discloses foamed blends of polychloroprene and 5-25 wt. % ethylene acid copolymer ionomers. These blends are prepared by mixing solid polychloroprene with the ethylene/acid copolymer or an ethylene acid copolymer ionomer. U.S. Pat. No. 4,235,980 discloses ter-ionomer blends wherein one component is a chloroprene/methacrylic acid copolymer and a second component is an ethylene/alpha, beta-unsaturated carboxylic acid copolymer.

It would be desirable to have available a cost effective process for production of a polychloroprene composition that could be used in preparation of molded goods and adhesive compositions wherein enhanced metal adhesion is necessary. It would also be desirable to have available a polychloroprene composition that exhibits the excellent high temperature adhesion properties of chloroprene methacrylic acid copolymer compositions as well as the more easily controlled, and less costly process of anionic polymerization or copolymerization.

### SUMMARY OF THE INVENTION

The present invention is directed to polychloroprene polymer compositions that have excellent adhesion to metal.

In one embodiment the invention is directed to a polychloroprene blend composition comprising
A. a first polymer comprising polymerized units of 2-chloro-1,3-butadiene; and
B. a second polymer comprising i) a polymer resin comprising copolymerized units of ethylene and a comonomer selected from the group consisting of methacrylic acid, acrylic acid, and mixtures thereof, ii) an ionomer of said polymer resin, and iii) mixtures of two or more thereof,
wherein the amount of second polymer in the blend composition is from 0.1-1.6 weight percent, based on the total weight of the first and second polymers.

In another embodiment, the invention is directed to a process for isolating a self-supporting film or sheet of a polychloroprene blend composition the process comprising the steps of
A. providing a first aqueous dispersion of a first polymer comprising copolymerized units of 2-chloro-1,3-butadiene;
B. forming an aqueous mixture by adding to said first aqueous dispersion an aqueous composition comprising a second polymer, said second polymer comprising a resin selected from the group consisting of i) a polymer resin comprising copolymerized units of ethylene and a comonomer selected from the group consisting of methacrylic acid, acrylic acid, and mixtures thereof, ii) an ionomer of said polymer resin, and iii) mixtures of two or more thereof, wherein the amount of the second polymer added to the first aqueous dispersion is from 0.1-1.6 weight percent, based on the total weight of the first and second polymers and wherein the addition takes place under conditions such that the pH of the mixture is greater than 9.0;
C. acidifying said aqueous mixture to form a second aqueous dispersion, thereby converting any ionomers present to copolymers comprising copolymerized units of ethylene and a comonomer selected from the group consisting of methacrylic acid, acrylic acid, and mixtures thereof;
D. introducing said second aqueous dispersion to the surface of a rotating freeze roll, thereby coagulating said second aqueous dispersion to form a film or sheet comprising a mixture of said first copolymer and said second polymer, wherein the polymer blend composition comprises no more than about 1.6 wt. percent of the second polymer based on the total weight of said first and second polymers present in said polymer blend composition; and
E. removing the film or sheet from the freeze roll.

The invention is further directed to a process for preparing a polychloroprene adhesive composition comprising the steps of
A. providing a polymer blend composition prepared by a process comprising the steps of
1. providing a first aqueous dispersion of a first polymer comprising copolymerized units of 2-chloro-1,3-butadiene;
2. forming an aqueous mixture by adding to said first aqueous dispersion an aqueous composition comprising a second polymer, said second polymer comprising a resin selected from the group consisting of i) a polymer resin comprising copolymerized units of ethylene and a comonomer selected from the group consisting of methacrylic acid, acrylic acid, and mixtures thereof, ii) ionomers of said polymer resin, and iii) mixtures of two or more thereof, wherein the amount of second polymer added is from 0.1-1.6 weight percent, based on the total weight of the first and second polymers and wherein the addition takes place under conditions such that the pH of the mixture is greater than 9.0;
3. acidifying said aqueous mixture to form a second aqueous dispersion, thereby converting any ionomers present to copolymers comprising copolymerized units of ethylene and a comonomer selected from the group consisting of methacrylic acid, acrylic acid, and mixtures thereof;
4. introducing said second aqueous dispersion to the surface of a rotating freeze roll, thereby coagulating said second aqueous dispersion to form a film or sheet comprising a mixture of said first copolymer and said second polymer, wherein the polymer blend composition comprises no more than about 1.6 wt. percent of the second polymer based on the total weight of said first and second polymers present in said polymer blend composition; and
5. removing the film or sheet from the freeze roll; and
B. forming a polychloroprene adhesive composition comprising said polymer blend composition by dissolving said polymer blend composition in an organic solvent.

### DETAILED DESCRIPTION OF THE INVENTION

In one embodiment, the present invention is directed to a novel blend of a chloroprene polymer and an ethylene unsaturated acid copolymer or an ionomer of an ethylene unsaturated acid copolymer. The polymer blend comprises a first component that is a polymer comprising copolymerized units of 2-chloro-1,3-butadiene and optionally other comonomers, for example sulfur (i.e. a chloroprene sulfur copolymer) and about 0.1-1.6 wt. % of a second component that may be an ethylene copolymer resin comprising copolymerized units of ethylene and an unsaturated acid selected from the group consisting of methacrylic acid, acrylic acid, an ionomer of such ethylene copolymer resins, and mixtures thereof.

The term “ionomer” as used herein refers to a polymer that comprises ionic groups that are carboxylate salts, for example, ammonium carboxylates, alkali metal carboxylates, and/or combinations of such carboxylates. Such polymers are generally produced by partially or fully neutralizing the carboxylic acid groups of precursor or parent polymers that are acid copolymers, as defined herein, for example by reaction with a base. An example of an alkali metal ionomer as used herein is a sodium ionomer (or potassium neutralized mixed ionomer), for example a copolymer of ethylene and methacrylic acid wherein all or a portion of the carboxylic acid groups of the copolymerized methacrylic acid units are in the form of sodium carboxylates and/or potassium carboxylates.

As used herein, the term “copolymer” refers to polymers comprising copolymerized units resulting from copolymerization of two or more comonomers. In this connection, a copolymer may be described herein with reference to its constituent comonomers or to the amounts of its constituent comonomers, for example “a copolymer comprising ethylene and 10 weight percent methacrylic acid”, or a similar description. Such a description may be considered informal in that it does not refer to the comonomers as copolymerized units; in that it does not include conventional nomenclature for the copolymer, for example International Union of Pure and Applied Chemistry (IUPAC) nomenclature; in that it does not use product-by-process terminology; or for another reason. As used herein, however, a description of a copolymer with reference to its constituent comonomers or to the amounts of its constituent comonomers means that the copolymer contains copolymerized units (in the specified amounts when noted) of the stated comonomers. It follows as a corollary that a copolymer is not the product of a reaction mixture containing given comonomers in specific amounts, unless expressly stated in limited circumstances to be such.

The term “dipolymer” refers to copolymers consisting essentially of two monomers, and the term “terpolymer” refers to copolymers consisting essentially of three monomers.

The polychloroprene polymers and copolymers that are components of the polymer blend composition of the invention are well known elastomers and are available commercially for example, from DuPont Performance Elastomers L.L.C. under the trade designation Neoprene W or Neoprene G polychloroprenes. Neoprene W polychloroprenes are prepared by the polymerization of chloroprene monomer in the presence of a chain transfer agent, for example an alkyl mercaptan, such as dodecyl mercaptan, or a xanthogen disulfide, such as diisopropyl xanthogen disulfide. Optionally, other comonomers may be copolymerized with chloroprene, generally in amounts of up to about 20 weight percent, based on the total weight of the resulting copolymer. Such comonomers include 2,3-dichloro-1,3-butadiene and sulfur.

The Neoprene G polychloroprene copolymers are made by polymerization of chloroprene in the presence of elemental sulfur. Optionally, other unsaturated monomers may be copolymerized with the chloroprene to form higher order chloroprene sulfur copolymers that comprise copolymerized units of chloroprene, the additional comonomer(s) and sulfur. The polymers thereby produced contain sulfur atoms in the backbone of the polymer chain as well as sulfur bridges between polymer chains. The chloroprene sulfur copolymers useful in the practice of the invention thus can be properly described as highly crosslinked chloroprene/sulfur copolymers and chloroprene/sulfur/comonomer copolymers.

Due to their crosslinked structure, chloroprene sulfur copolymers cannot be processed directly but must first be broken down to provide copolymers of lower molecular weight. This step, known as peptization, is normally accomplished by treating the sulfur copolymer latex that is produced during the emulsion polymerization process with a tetraalkylthiuram disulfide, sometimes in combination with a sodium dialkyl dithiocarbamate. Preparation and peptization of sulfur-modified chloroprene polymers (i.e. chloroprene/sulfur copolymers) is described, for example, in the following U.S. patents: U.S. Pat. No. 2,234,215 (Youker); U.S. Pat. No. 3,595,847 (Mayer-Mader); and U.S. Pat. No. 3,920,623 (Khan). In commercially available chloroprene sulfur copolymers, the amount of sulfur is generally in the range of 0.2-0.6 phr (where phr is parts per hundred parts rubber), preferably in the range of 0.2-0.5 phr. At such levels a rather significant number of interchain sulfur crosslinks are introduced. Opening of such crosslinks in the peptization process can provide a product having fairly low molecular weight. Generally, it is desired to produce a polymer having a molecular weight above the theoretical minimum, and peptization is stopped before the peptization process is complete. The peptized polymer latex may be stored for some time before isolatation of the polymer, preferably under conditions which do not lead to further molecular weight changes, i.e. under conditions that would not lead to further decrease of molecular weight due to continued peptization or increase of molecular weight due to crosslinking. Such changes are undesirable because they affect both the processability and the mechanical properties of the polymer.

Suitable ethylene acid copolymers and ethylene acid copolymer ionomers that are useful components of the polymer blend composition of the invention are those which are soluble in water at pH 10. These include ethylene copolymers comprising copolymerized units of acrylic acid and/or methacrylic acid and optionally additional small amounts, e.g. less than 5 wt. %, of additional comonomers, as well as ionomers of such ethylene acid copolymers. The additional comonomers may include esters of the above named acids, such as methyl acrylate and methyl methacrylate. Generally, the ethylene carboxylic acid copolymers or ionomers will be ethylene acrylic acid copolymers or ethylene methacrylic acid copolymers or their ionomers wherein the weight percentage of copolymerized acrylic acid or methacrylic acid units ranges up to about 25 wt. %, based on the weight of the ethylene carboxylic acid copolymer. Generally the amount of acid comonomer ranges from about 2 wt. % to about 23 wt. %.

In certain embodiments, ethylene acrylic acid copolymers are preferred. The ethylene acrylic acid copolymers useful in the practice of the invention may have melt flow rates (MFR) of about 5 to about 2500 g/10 min, about 10 to about 1400 g/10 min, about 35 to about 1200 g/10 min, about 70 to about 1000 g/10 min, about 100 to about 500 g/10 min, or about 200 to about 500 g/10 min, as determined in accordance with ASTM method D1238 at 190° C. and under a load of 2.16 kg. Ethylene acrylic acid copolymers are commercially available as Primacor® resins from The Dow Chemical Co. Such polymers generally have acid contents of greater than 17 weight percent to about 25 weight percent based on the weight of the ethylene copolymer.

In certain embodiments, ionomers of ethylene methacrylic acid copolymers are preferred. For example, Surlyn® resin ionomers are commercially available ethylene methacrylic acid ionomers, available from E. I. du Pont de Nemours and Company.

The ethylene unsaturated acid copolymers useful in the invention may be synthesized in a continuous process in which each of the reactive comonomers and the solvent or solvents, if any, are continuously fed, together with initiator, into a stirred reactor. The choice of initiator is based on the anticipated reactor temperature range coupled with the decomposition temperature of the initiator, the criteria for this selection being well-understood in the industry. In general, during the synthesis by copolymerization of ethylene and acid comonomers to produce the acid copolymer, the reaction temperature may be maintained at about 120° C. to about 300° C., or about 140° C. to about 260° C. The pressure in the reactor may be maintained at about 130 to about 310 MPa, or about 165 to 250 MPa.

The reactor may be, for example, an autoclave such as those described in U.S. Pat. No. 2,897,183. Specifically, U.S. Pat. No. 2,897,183 describes a type of autoclave that is equipped with means for intensive agitation. It also describes a continuous process for the polymerization of ethylene under a “substantially constant environment.” This environment is maintained by keeping certain parameters, for example, pressure, temperature, initiator concentration and the ratio of polymer product to unreacted ethylene, substantially constant during the polymerization reaction. Such conditions may be achieved in any of a variety of continuously stirred tank reactors, among them, for example, continuously stirred isothermal reactors and continuously stirred adiabatic reactors.

The reaction mixture, which contains the ethylene copolymer product, is vigorously agitated and continuously removed from the autoclave. After the reaction mixture leaves the reaction vessel, the resulting ethylene copolymer product is separated from the volatile unreacted monomers and solvents, if any, by conventional procedures, such as by vaporizing the unpolymerized materials and solvents under reduced pressure or at an elevated temperature. Preferred unsaturated carboxylic acid comonomers include acrylic acid and methacrylic acid.

Combinations of acid copolymers are also suitable for use in the present invention, provided that the solubility properties of the copolymers are adequate. For example, two or more dipolymers having differing amounts of copolymerized carboxylic acid comonomer or differing melt indices (i.e. melt flow rates) may be used. Also, a combination of precursor acid copolymers including a dipolymer and a terpolymer may be suitable.

Ionomers useful in the compositions and processes described herein may be prepared from the above-described precursor acid copolymers by neutralization with a base so that the carboxylic acid groups in the precursor acid copolymer react to form carboxylate groups. Preferably, the precursor acid copolymers groups are neutralized to a level of about 20 to about 100 wt %, based on the total carboxylic acid content of the precursor acid copolymers as calculated or measured for the non-neutralized precursor acid copolymers. Although any stable cation is believed to be suitable as a counterion to the carboxylate groups in the ionomer, divalent and monovalent cations, such as cations of alkali metals, alkaline earth metals, and some transition metals, are preferred. The precursor acid copolymers may be neutralized by any conventional procedure, such as those disclosed in U.S. Pat. Nos. 3,404,134 and 6,518,365.

If a base is used as a neutralizing agent to form the ionomers, it will preferably be a sodium ion-containing base, to provide a sodium ionomer wherein about 70% to about 100%, or about 85% to about 100%, or about 90% to about 98% of the hydrogen atoms of the carboxylic acid groups of the precursor acid are replaced by sodium cations. In other embodiments, the base may be an ammonium ion-containing base or a potassium ion-containing base.

Polymer blends of the invention will comprise from about 0.1 to about 1.6 wt. % of ethylene unsaturated acid copolymer or ionomer, based on the combined weight of polychoroprene polymer and the ethylene acid copolymer or ionomer. Preferably, the ethylene acid copolymer or ionomer will be present in an amount of from 0.3-1.6% wt. %, more preferably in an amount of from 0.5-1.4 wt. %, and most preferably in an amount of 0.6-1.2 wt. %. If amounts greater than 2 wt. % are used a dispersion of the blend becomes increasing difficult to isolate on a freeze roll.

The polymer blend of the invention may be prepared by any technique or method by which chloroprene polymers and ethylene acid copolymers may be combined. For example, the individual solid polymer components may be blended in a mechanical mixer or a Banbury® mixer to form a solid composition of the invention. Alternatively, the individual components may be blended by mixing solutions or emulsions of the chloroprene polymers and ethylene acid copolymers or ionomers. This will produce an aqueous composition of the invention. Preferably, the polymer components will be blended by mixing of solutions or emulsions, resulting in production of a highly homogeneous composition. If the polymer components are mixed when in the form of solutions or dispersions, the polychloroprene will usually be in the form of an aqueous dispersion. The mixing of two dispersions will naturally provide the most intimate mixture available since the particle size of the dispersion is small. In some embodiments, the dispersion that is used to prepare the polymer blend of the invention may be an aqueous dispersion that was formed during a polychloroprene polymerization or copolymerization reaction with sulfur which was subsequently peptized. Such peptized dispersions are not available commercially, but may be prepared as taught in U.S. Pat. No. 2,234,215 (Youker); U.S. Pat. No. 3,595,847 (Mayer-Mader); and U.S. Pat. No. 3,920,623 (Khan).

If the chloroprene dispersion component is obtained directly from a polymerization reaction it may contain various other materials, such as additives, by-products and stabilizing agents normally found in the aqueous dispersions that are produced in chloroprene polymerization reactions. Such additives may include unreacted comonomers, rosin or resin salts, polymerization stabilizers such as phenothiazine and/or tert-butyl catechol, surfactants such as Lomar® PW, and by-products such as inorganic sulfate salts.

If the polymer blend of the invention is prepared using an ethylene acrylic or methacrylic acid copolymer or ionomer, such material may also comprise additional components. Such components may include residual monomer and polymerization by-products.

In addition, the blend of chloroprene polymer and ethylene acid copolymer may be prepared by mixing a dispersion of the chloroprene polymer and an ionomer of an ethylene acrylic acid or ethylene methacrylic acid copolymer and adjusting the pH of the resultant mixture, if necessary, to below 7, thereby converting the ionomer to its acid form.

The blend of polychloroprene and ethylene acid copolymer or ionomer of the invention may further comprise small amounts of any suitable additive known in the art. Such additives include, but are not limited to, plasticizers, processing aids, flow enhancing additives, flow reducing additives (e.g., organic peroxides), lubricants, pigments, dyes, optical brighteners, flame retardants, impact modifiers, nucleating agents, antiblocking agents (e.g., silica), thermal stabilizers, hindered amine light stabilizers (HALS), UV absorbers, UV stabilizers, dispersants, surfactants, chelating agents, coupling agents, adhesives, primers, reinforcement additives (e.g., glass fiber), fillers, and the like, and mixtures or combinations of two or more conventional additives. These additives are described in the Kirk Othmer Encyclopedia of Chemical Technology, 5^{th} Edition, John Wiley & Sons (New Jersey, 2004), for example.

These conventional ingredients may be present in the compositions in quantities that are generally from 0.01 to 1 weight %, preferably from 0.01 to 0.5 weight %, so long as they do not detract from the basic and novel characteristics of the composition and do not significantly adversely affect the performance of the polychloroprene/ethylene acid copolymer composition. In this connection, the weight percentages of such additives are not included in the total weight percentages of the acid copolymer and ionomer compositions defined herein.

In some embodiments, the polymer blend of the invention is advantageously made by a process that comprises the following general steps. An aqueous dispersion of a 2-chloro-1,3-butadiene polymer is mixed with an aqueous solution or dispersion of an ethylene unsaturated acid copolymer, an ionomer of an ethylene unsaturated acid copolymer, or a mixture thereof, thereby forming an aqueous dispersion. The conditions of mixing are such that the pH of the dispersion is greater than 9.0, preferably greater than 10. The resultant mixture is then acidified, generally to a pH of 5.5 to 6.5 to form a second aqueous dispersion. This results in conversion of any ionomers present to their acid copolymer form.

When prepared by blending a polychloroprene emulsion or dispersion with an aqueous solution or dispersion of the ethylene unsaturated acid copolymer or ionomer, the blend of chloroprene polymer and ethylene acid copolymer or ionomer is generally isolated by coagulation of the polymers. On an industrial scale, coagulation of conventional chloroprene polymer dispersions is most effectively accomplished using a freeze roll. The blend of the invention is also capable of being isolated from the acidified dispersion produced by the process of the invention by coagulation on a freeze roll, which is a cost effective method of isolation for polychloroprene rubbers.

In operation, a drum, generally chilled to a temperature at or below −12° C., rotates through a container of the chloroprene blend dispersion resulting in formation of a frozen polymeric film or sheet on the drum. Typically, the film or sheet will be removed from the freeze roll using a doctor knife. For efficient isolation, the film or sheet should be self-supporting, by which is meant that it supports its own weight without tearing while being pulled from the doctor knife and maintains its integrity while being water-washed. Thus, in one embodiment of the invention a process is provided whereby a self-supporting film or sheet of a polymer blend comprising a chloroprene polymer and an ethylene acid copolymer or ionomer is formed.

The mixture of polychloroprene and ethylene acid copolymer or ionomer will generally contain no more than 1.6 wt. % ethylene acid copolymer based on the total weight of chloroprene polymer and ethylene acid copolymer or ionomer. Such mixtures are capable of forming self-supporting films or sheets when cooled to −15° C. on a freeze roll as described in U.S. Pat. No. 2,167,146 to Calcott et al. The film or sheet can be collected and removed from the freeze roll in any manner, usually by being formed into a rope which is later cut into chips and packaged.

The self-supporting polymer blend film or sheet prepared as described above will generally be heated and dried, preferably in a serpentine dryer at a temperature of between 90° C.-120° C. to form a material that can be packaged and is suitable for use as an elastomer, generally as an elastomer for use in adhesive formulations. For example, the dried polymer blend film or sheet will generally be converted into solid polymer chips by gathering the film or sheet into a rope and cutting the rope into small pieces or chips, generally in size of about 1×2×⅛ inches. These chips generally are coated with an anti-massing agent, such as talc.

Although the blend is most effectively isolated by use of a freeze roll, isolation may also be accomplished using means such as steam-heated drum dryers.

The process of the invention provides compositions that are easily recoverable and may be used to form rubber articles, such as seals, gaskets, air-springs, bridge-bearing pads, or engine mounts, as well as adhesive compositions.

The process described herein for producing a self-supporting film or sheet of a chloroprene polymer blend provides chloroprene polymer blend compositions that are suitable for use in preparing solvent-based adhesives having enhanced high temperature resistance and in preparing molding compositions having improved adhesion to metal. In one particular embodiment, the process of the present invention can be used to produce adhesives comprising polychloroprene sulfur copolymers that have excellent high temperature resistance and also exhibit high bond strength and improved adhesion to metal. By improved adhesion to metal is meant that the adhesive strength, as measured in accordance with a modified ASTM D429, Method B protocol, as described herein, of a substrate comprising the blend of polychloroprene and ethylene unsaturated acid copolymer or ionomer, when bonded to a metal surface is greater than the adhesive strength of a substrate comprising the chloroprene polymer alone when bonded to a metal surface.

In another embodiment of the invention adhesive compositions are prepared by mixing the polychloroprene and ethylene unsaturated acid copolymer or ionomer components of the polymer blend of the invention with an organic solvent. The polymer components may be mixed with the solvent either as a pre-formed blend composition (for example as chips or pellets isolated from a self-supporting polymer film or sheet) or as separate components. Typical organic solvents useful for this purpose include toluene, acetone, and hexane. Preferred solvents include toluene and blends of toluene with acetone and/or hexane.

The organic solvent may contain various additives and compounding agents commonly used in solvent-based chloroprene adhesive compositions. Such additives include crosslinking agents, such as diethyl thiourea; metal oxides; antioxidants; antiozonants, such as Wingstay® L, Santowhite® crystals and Antozite®; rosins, such as 1-t-butylphenolic maleic anhydride-modified rosin esters; tackifying resins, for example, hydrocarbon resins, such as Cumar® resins from Neville Chemical Co., or Piccolyte ® resins from Pinova, Inc, or tert-butyl phenolic resins available from HRJ and SP series resins available from SI Group. The additives may be present in the organic solvent when it is combined with the chloroprene polymer or the additional components may be added after the chloroprene polymer is dissolved. The mixing procedure and formulation will depend upon the particular additives and chloroprene polymer type and will be known to those skilled in the art of preparing adhesive formulations. The amounts employed will be those conventionally used with polychloroprene adhesives and will be known to those skilled in the art. For example, a metal oxide will generally be used in an amount of 2 to 10 parts per hundred parts of the mixture of polychloroprene and ethylene acid copolymer or ionomer. The metal oxide component of the adhesive compositions, for example magnesium oxide or zinc oxide, acts as both acid acceptor and curing co-agent and reduces acid tendering of the adhesives. The metal oxides contribute to curing by reaction with either the polychloroprene and/or the resin components, particularly if the resins are t-butyl phenolic resins. Generally the metal oxides, which act as crosslinking agents, are present at a level of about 2 to about 10 parts of metal oxide per one hundred parts of either polychloroprene/ethylene acid copolymer or ionomer blend in the adhesive. The metal oxides can be added singly or in combination. They are preferably used in combination at a concentration of 4 to 8 phr of each component. Zinc and magnesium oxide are preferred metal oxides, but other metal oxides, such as the oxides of calcium, tin or lead are also suitable for use. Amounts of other additives are known to those skilled in the art.

Additionally, if a rosin tackifier is present, it will be used in an amount of from about 1 to about 75 parts per 100 parts of the polychloroprene/ethylene acid copolymer or ionomer blend. The rosins suitable for use include, for example, acids or terpenoid esters such as esters of abietic acid, hydrogenated abietic acid, disproportionated abietic acid, or polymerized abietic acid. Normally, the esters are lower alkyl esters of two to six carbon atoms, but this is not a critical limitation. Also, mixtures of rosins are contemplated. Rosins modify adhesive characteristics, e.g., tack, adhesion, cohesion and hot bond strength. Adhesives of the present invention containing rosin concentrations of 1 to 75 parts per 100 parts polychloroprene/ethylene acid copolymer or ionomer blend exhibit rapid bond strength development and high temperature resistance. Poor adhesion to some surfaces results if levels of less than 1 part rosin are used. In contrast, if greater than 75 parts are used, the heat resistance of the compositions is decreased. Preferably 10-60 parts rosin are used per 100 parts of polychloroprene/ethylene acid copolymer or ionomer blend.

The adhesives formed by the process of the invention have outstanding high temperature properties. That is, they are generally characterized by exhibiting peel strengths of above 8 pounds per linear inch (pli) at room temperature, when measured according to the modified ASTM D429, Method B protocol described herein. In addition, they exhibit improved peel strengths at temperatures in excess of 100° C. compared to chloroprene polymer compositions that do not contain the ethylene unsaturated acid copolymer or ionomer component. This permits adequate adhesion between surfaces during manufacture of bonded articles at temperatures above 60° C. and results in excellent adhesion in articles that are subjected to temperatures above 35° C.

Polymer blends of the invention that comprise polychloroprenes that do not contain copolymerized sulfur units are best suited for manufacture of adhesive products used in structural assembly processes, such as counter-top lamination or automotive interior assembly. They are also useful for manufacture of cured articles such as belts or hoses, particularly when the polymer blend is laminated to a support layer comprising metallic fibers or strands. Examples of such adhesive uses include headliners of automobiles or trailers and laminated kitchen surfaces suitable for use near a stovetop. The blends of the invention that comprise sulfur-containing chloroprene polymers are useful as components in primers or adhesives for bonding to metals, or as molded parts that are bonded to metals, for example, engine mounts. The ambient temperature adhesive strength exhibited by adhesives of the invention that comprise a blend of polychloroprene and ethylene acid copolymer is significantly greater than that of adhesives of the same formulation but wherein the polymer component is a polychloroprene sulfur copolymer alone.

In one aspect, the process of the invention is particularly adapted to manufacture of solid chloroprene sulfur copolymer compositions that can be molded into articles having good adhesion to metal. In another aspect, the process of the invention is particularly adapted to manufacture of organic solvent-based chloroprene sulfur copolymer adhesives having good high temperature adhesion properties. For example, a chloroprene sulfur copolymer adhesive that is formulated from a blend of chloroprene sulfur copolymer and ethylene acrylic acid copolymer is characterized by having an increase in adhesive strength to unprimed steel, as measured in accordance with the modified ASTM D429, Method B procedure described herein, of between 15 to 200% compared to an adhesive of the same formulation that contains chloroprene sulfur copolymer as the sole polymer component. For instance, when 1.6 wt. % polyethylene-co- acrylic acid is mixed with 98.4 wt. % chloroprene sulfur copolymer, based on the total weight of ethylene copolymer and chloroprene sulfur copolymer, the median first peak adhesive strength is nearly doubled from 7.3 pli to 14.4 pli (197% improvement). When 0.76 wt. % polyethylene-co-acrylic acid is added to the chloroprene sulfur copolymer, based on the total weight of ethylene copolymer and chloroprene sulfur copolymer, the adhesive strength is increased by 68.5%.

The test procedure utilized is as follows. Bonded test specimens for use in testing tensile shear strength are prepared using a modified ASTM D429, Method B procedure as follows. Canvas strips (1×6 inches and clean unprimed steel substrates (1×2.5×⅛ inches, are each coated twice with solvent-borne adhesive using 0.3 g of adhesive in each coat. The area coated on each substrate is 2 inches in length. The test specimen substrates are allowed to dry for 10 minutes. Each substrate was then placed in an oven heated to a temperature of 92° C. and allowed to remain in the oven for 5 minutes. The substrates are then removed from the oven, pressed together, and three samples are rolled side-by-side using a 4″ diameter roller loaded with a weight of 180 lbs (providing a bonding pressure of 60 lbs per linear inch (pli) per sample). The specimens are aged for 2 hours at room temperature. The resultant aged assemblies are tested according to testing protocol ASTM D429 (Method B) at room temperature (23° C.) and optionally at 100° C.

The invention is further illustrated by the following examples of certain embodiments.

### EXAMPLES

### Comparative Example A

A dodecylmercaptan modified chloroprene homopolymer dispersion was prepared by feeding a mixture of 100 parts chloroprene, 3 parts rosin and 0.22 parts dodecylmercaptan to a glass/glass-lined polymerization reactor containing an aqueous solution of 84 parts water, 0.46 parts sodium hydroxide, 0.4 parts sodium naphthalene sulfonate, and 0.15 parts sodium sulfite at ambient temperature. The temperature of the reaction mixture was increased to 45° C. and polymerization was initiated by introduction of a dilute aqueous solution of potassium persulfate and sodium anthraquinone sulfonate. The polymerization was short-stopped by addition of aqueous solutions of phenothiazine and t-butyl catechol when the conversion reached a level of 68%. Unreacted monomer was removed by steam stripping. The dispersion was acidified with acetic acid to a pH of 5.5 and placed in contact with a freeze roll to form a solid polymer sheet that was removed from the freeze roll and subsequently dried. The resultant polymer composition had a Mooney viscosity of 46.9, ML 1+4 at 100° C., as determined according to ASTM D1646.

An adhesive composition was prepared from the polymer composition as follows. A sample of the dried polymer composition was compounded on a rubber mill with magnesium oxide, zinc oxide and Wingstay® L, in the amounts listed in Table I. The resultant blend was cut into small pieces and added to a mixture of toluene, water, and SP54 (a heat reactive phenolic resin tackifier, available from SI Group). The amounts of toluene, water and SP54 used were as listed in Table I. The resultant mixture was agitated for 24 hours using a roll mixer until it was homogeneous, thereby forming a solvent-borne adhesive. Bonded test specimens (assemblies) for use in testing tensile shear strength were prepared using a modified ASTM D429, Method B procedure as follows. Canvas strips (1×6 inches) and clean unprimed steel substrates (1×2.5×⅛ inches) were each coated twice with the solvent-borne adhesive using 0.3 g of adhesive in each coat. The area coated on each substrate was 2 inches in length. The test specimen substrates were allowed to dry for 10 minutes. Each substrate was then placed in an oven heated to a temperature of 92° C. and allowed to remain in the oven for 5 minutes. The substrates were then removed from the oven, pressed together, and three samples were rolled side-by-side using a 4″ diameter roller loaded with a weight of 180 lbs (providing a bonding pressure of 60 lbs per linear inch (pli) per sample) to form test specimens (assemblies). The assemblies were aged for 2 hours at room temperature. The resultant aged assemblies were tested using the protocol of ASTM D429 (Method B) at both room temperature (23° C.) and 100° C. A group of six aged assemblies prepared as described above were tested for adhesion. The median force measured for the first test peak (calculated from the median values of the first peak of each of the six assemblies) is reported in Table I. In addition, the median value for the combined peaks for each assembly was used to calculate an overall combined median. This value is also reported in Table I.

### Example 1

A sample of the dispersion of dodecylmercaptan modified chloroprene homopolymer prepared according to the procedure described in Comparative Example A was blended with an aqueous solution of a sodium ionomer prepared as follows. A sample of Primacor® 59801 resin (a polyethylene-co-acrylic acid available from The Dow Chemical Company) was blended with an aqueous sodium hydroxide solution. The amount of Primacor® 5980I resin used was sufficient to provide a 5 wt. % aqueous polymer solution. The amount of sodium hydroxide present in the sodium hydroxide solution was the amount necessary to convert 100% of the carboxylic acid groups in the Primacor® resin to sodium carboxylate salts. The mixture was then heated with stirring until the Primacor® pellets dissolved. The solution was cooled and the pH adjusted to greater than 10 by adding sodium hydroxide. The amount of the aqueous sodium ionomer solution added to the dodecylmercaptan modified chloroprene homopolymer dispersion was 9.1 parts aqueous sodium ionomer solution per 100 parts chloroprene monomer charged to the reactor during polymerization. The resultant dispersion was acidified with acetic acid to a pH of 5.5, thereby forming a chloroprene homopolymer/polyethylene-co-methacrylic acid dispersion. A solid polymer blend composition was isolated from the acidified dispersion by contacting it with a freeze roll to form a solid polymer sheet that was collected from the freeze roll and subsequently dried. The resultant polymer blend composition contained 0.69 wt. % ethylene acrylic acid copolymer, based on the total weight of the ethylene acrylic acid copolymer plus dodecylmercaptan modified chloroprene homopolymer in the polymer blend. The polymer blend had a Mooney viscosity of 46, ML 1+4 at 100° C., as determined according to ASTM D1646. An adhesive composition and test assemblies were prepared as described in Comparative Example A. Adhesion tests were conducted in the same manner as described in Comparative Example A and test results are shown in Table I.

### Comparative Example B

A dispersion of chloroprene, sulfur and 2,3-dichloro-1,3-butadiene was prepared at ambient temperature by feeding a mixture of 98 parts chloroprene, 2.0 parts 2,3-dichloro-1,3-butadiene and 3.94 parts rosin to a glass/glass-lined polymerization reactor containing an aqueous solution of 106 parts water, 0.65 parts sodium hydroxide, 0.00004 parts copper sulfate (13.2% solution); and an aqueous dispersion containing 1.8 parts water, 0.6 parts sulfur, 0.4 parts sodium naphthalene sulfonate, 0.005 parts sodium anthraquinone sulfonate, and 0.16 Dresinate® 91-44 rosin soap (available from Eastman Chemical Co.). The temperature of the reaction mixture was increased to 39° C. and polymerization was initiated by introduction of a dilute aqueous solution of potassium persulfate and sodium anthraquinone sulfonate. The polymerization was short-stopped by addition of an aqueous dispersion of 5% Santonox® TBMC preservative (available from The Monsanto Chemical Co.) and 23.5% tetraethylthiuram disulfide when the conversion reached a level of 82%. An aliquot of 0.86 parts of a 47% aqueous solution of sodium diethyldithiocarbamate was then added to begin peptization. After 3 hours the unreacted monomer was removed from the polymer dispersion by steam stripping and the polymer dispersion was treated with 3 parts of a 30% aqueous dispersion of tetrabutylthiuram disulfide. The dispersion was held at room temperature for 33 hours and then acidified with acetic acid to a pH of 5.5 and placed in contact with a freeze roll to form a solid polymer sheet that was removed from the freeze roll and subsequently dried. The resultant polymer composition had a Mooney viscosity of 42.1 ML 1+4 at 100° C., as determined according to ASTM D1646. An adhesive composition and test assemblies were prepared as described in Comparative Example A. Adhesion tests were conducted in the same manner as described in Comparative Example A and room temperature test results are shown in Table I.

### Example 2

A chloroprene sulfur copolymer dispersion, prepared substantially as described as in Comparative Example B, was mixed with 13.9 parts of an aqueous solution of a sodium ionomer that was prepared from polyethylene/methacrylic acid (Primacor®5980I) as described in Example 1. The addition of the ionomer solution to the chloroprene sulfur copolymer dispersion took place after the 33 hour room temperature hold time was complete. The dispersion was then acidified with acetic acid to a pH of 5.5 and placed in contact with a freeze roll to form a solid polymer sheet that was removed from the freeze roll and subsequently dried. The resultant polymer composition, which was a blend of 99.24 wt. % chloroprene sulfur copolymer and 0.76 wt. % ethylene acrylic acid copolymer, wherein the weight percentages are based on the total weight of the chloroprene sulfur copolymer plus ethylene acrylic acid copolymer, had a Mooney viscosity of 40.1 (ML 1+4 at 100° C.), as determined according to ASTM D1646. An adhesive composition and test assemblies were prepared as described in Comparative Example A. Adhesion tests were conducted in the same manner as described in Comparative Example A and room temperature test results are shown in Table I.

### Example 3

A chloroprene sulfur copolymer dispersion, prepared substantially as described in Comparative Example B, was mixed with 27.8 parts of an aqueous solution of a sodium ionomer prepared from polyethylene/acrylic acid (Primacor® 5980I) as described in Example 1. The addition of the sodium ionomer solution took place after the 33 hour room temperature hold time was complete. The dispersion was then acidified with acetic acid to a pH of 5.5 and placed in contact with a freeze roll to form a solid polymer sheet that was removed from the freeze roll and subsequently dried. The resultant polymer composition, which was a blend of 98.49 wt. % chloroprene sulfur copolymer and 1.51 wt. % ethylene acrylic acid copolymer, wherein the weight percentages are based on the total weight of the chloroprene sulfur copolymer plus ethylene acrylic acid copolymer, had a Mooney viscosity of 40.1 (ML 1+4 at 100° C.), as determined according to ASTM D1646. An adhesive composition and test assemblies were prepared as described in Comparative Example A. Adhesion tests were conducted in the same manner as described in Comparative Example A and room temperature test results are shown in Table I.

### Comparative Example C

A chloroprene sulfur dispersion was prepared at ambient temperature by feeding a mixture of 100 parts chloroprene and 3.94 parts rosin to a glass/glass-lined polymerization reactor containing an aqueous solution of 93 parts water, 0.66 parts sodium hydroxide, 0.00004 parts copper sulfate (13.2% solution); and an aqueous dispersion containing 1.8 parts water, 0.3 parts sulfur, 0.4 parts sodium naphthalene sulfonate, 0.005 parts sodium anthraquinone sulfonate, and 0.16 Dresinate® 91-44 rosin soap (available from Eastman Chemical Co.). The temperature of the reaction mixture was increased to 42° C. and polymerization was initiated by introduction of a dilute aqueous solution of potassium persulfate and sodium anthraquinone sulfonate. The polymerization was short-stopped by addition of 2 parts of an aqueous dispersion of 5% Santonox® TBMC preservative (available from The Monsanto Chemical Co.) and 23.5% tetraethylthiuram disulfide when the conversion reached a level of 71%. An aliquot of 0.86 parts of a 47% aqueous solution of sodium diethyldithiocarbamate was then added to begin peptization. After 3 hours the unreacted monomer was removed from the polymer dispersion by steam stripping and the dispersion was treated with 1.9 parts of a 30% aqueous dispersion of tetrabutylthiuram disulfide. The dispersion was held at room temperature for 33 hours, and then acidified with acetic acid to a pH of 5.5 and placed in contact with a freeze roll to form a solid polymer sheet that was removed from the freeze roll and subsequently dried. The resultant polymer composition had a Mooney viscosity of 40.5, ML 1+4 at 100° C., as determined according to ASTM D1646. An adhesive composition and test assemblies were prepared as described in Comparative Example A. Adhesion tests were conducted in the same manner as described in Comparative Example A and room temperature test results are shown in Table I.

### Example 4

A chloroprene sulfur copolymer dispersion was prepared substantially as in example C. The dispersion was mixed with 13.6 parts of an aqueous solution of a sodium ionomer prepared from polyethylene/acrylic acid (Primacor® 5980I) as described in Example 1. The addition of the sodium ionomer solution took place after the 33 hour room temperature hold time was complete. The dispersion was then acidified with acetic acid to a pH of 5.5 and placed in contact with a freeze roll to form a solid polymer sheet that was removed from the freeze roll and subsequently dried. The resultant polymer composition, which was a blend of 99.05 wt. % chloroprene sulfur copolymer and 0.95 wt. % ethylene acrylic acid copolymer, wherein the weight percentages are based on the total weight of the chloroprene sulfur copolymer plus ethylene acrylic acid copolymer, had a Mooney viscosity of 43.8 (ML 1+4 at 100° C.), as determined according to ASTM D1646. An adhesive composition and test assemblies were prepared as described in Comparative Example A. Adhesion tests were conducted in the same manner as described in Comparative Example A and room temperature test results are shown in Table I.

TABLE I

| | Example A | Example 1 | Example B | Example 2 | Example 3 | Example C | Example 4 |
|---|---|---|---|---|---|---|---|
| Adhesive Composition | | | | | | | |
| Polymer Composition | 100 | 100 | 100 | 100 | 100 | 100 | 100 |
| Magnesium oxide¹ | 8 | 8 | 8 | 8 | 8 | 8 | 8 |
| Zinc oxide | 5 | 5 | 5 | 5 | 5 | 5 | 5 |
| Wingstay ® L² | 2 | 2 | 2 | 2 | 2 | 2 | 2 |
| Toluene | 652 | 652 | 652 | 652 | 652 | 652 | 652 |
| SP154³ | 49 | 49 | 49 | 49 | 49 | 49 | 49 |
| Water | 1 | 1 | 1 | 1 | 1 | 1 | 1 |
| Adhesion⁴ | | | | | | | |
| 23° C. (pli)⁵ | 7.6 | 12.2 | 6.1 | 11.2 | 12.3/9.8⁷ | 9.8/16⁷ | 18.0 |
| 23° C. (pli)⁶ | | | 7.3 | 12.3 | 14.4/11.4⁷ | 13.1/18.5⁷ | 20.0 |
| 100° C. (pli)⁵ | 0.33 | 0.67 | — | — | — | — | — |

¹Maglite ® D magnesium oxide, available from The HallStar Co.
²Butylated reaction product of p-cresol and dicyclopentadiene, available from Eliokem.
³Heat reactive phenolic resin tackifier, available from SI Group.
⁴Modified ASTM D429, Method B.
⁵Overall combined median.
⁶Median force measured by first peak.
⁷Values are presented for two sets of six aged assemblies

What is claimed is:

1. A polychloroprene composition comprising
A. a first polymer comprising polymerized units of 2-chloro-1,3-butadiene; and
B. a second polymer comprising a resin selected from the group consisting of i) a polymer resin comprising copolymerized units of ethylene and a comonomer selected from the group consisting of methacrylic acid, acrylic acid, and mixtures thereof, ii) an ionomer of said polymer resin, and iii) mixtures of two or more thereof,
wherein the amount of second polymer in the blend composition is from 0.1-1.6 weight percent, based on the total weight of the first and second polymers.

2. A polychloroprene composition of claim 1 wherein the second polymer is a polymer resin comprising copolymerized units of ethylene and a monomer selected from the group consisting of methacrylic acid, acrylic acid, and mixtures thereof.

3. A polychloroprene composition of claim 2 wherein the monomer is acrylic acid.

4. A polychloroprene composition of claim 1 wherein the second polymer is an ionomer of a polymer resin comprising copolymerized units of ethylene and a monomer selected from the group consisting of methacrylic acid, acrylic acid, and mixtures thereof.

5. A polychloroprene composition of claim 2 wherein the monomer is methacrylic acid.

6. A process for isolating a self-supporting film or sheet of a polychloroprene blend composition the process comprising the steps of
A. providing a first aqueous dispersion of a first polymer comprising copolymerized units of 2-chloro-1,3-butadiene;
B. forming an aqueous mixture by adding to said first aqueous dispersion an aqueous composition comprising a second polymer, said second polymer comprising a resin selected from the group consisting of i) a polymer resin comprising copolymerized units of ethylene and a comonomer selected from the group consisting of methacrylic acid, acrylic acid, and mixtures thereof, ii) an ionomer of said polymer resin, and iii) mixtures of two or more thereof, wherein the amount of the second polymer added to the first aqueous dispersion is from 0.1-1.6 weight percent, based on the total weight of the first and second polymers and wherein the addition takes place under conditions such that the pH of the mixture is greater than 9.0;
C. acidifying said aqueous mixture to form a second aqueous dispersion, thereby converting any ionomers present to copolymers comprising copolymerized units of ethylene and a comonomer selected from the group consisting of methacrylic acid, acrylic acid, and mixtures thereof;
D. introducing said second aqueous dispersion to the surface of a rotating freeze roll, thereby coagulating said second aqueous dispersion to form a film or sheet comprising a mixture of said first copolymer and said second polymer, wherein the polymer blend composition comprises no more than about 1.6 wt. percent of the second polymer based on the total weight of said first and second polymers present in said polymer blend composition; and
E. removing the film or sheet from the freeze roll.

7. A process of claim 6 wherein the second polymer is a polymer resin comprising copolymerized units of ethylene and a monomer selected from the group consisting of methacrylic acid, acrylic acid, and mixtures thereof.

8. A process of claim 6 wherein the second polymer is an ionomer of a polymer resin comprising copolymerized units of ethylene and a monomer selected from the group consisting of methacrylic acid, acrylic acid, and mixtures thereof.

9. A process of claim 7 wherein the monomer is acrylic acid.

10. A process for preparing a polychloroprene adhesive composition comprising the steps of
A. providing a polymer blend composition prepared by a process comprising the steps of
1. providing a first aqueous dispersion of a first polymer comprising copolymerized units of 2-chloro-1,3-butadiene;
2. forming an aqueous mixture by adding to said first aqueous dispersion an aqueous composition comprising a second polymer, said second polymer comprising a resin selected from the group consisting of i) a polymer resin comprising copolymerized units of ethylene and a comonomer selected from the group consisting of methacrylic acid, acrylic acid, and mixtures thereof, ii) ionomers of said polymer resin, and iii) mixtures of two or more thereof, wherein the amount of second polymer added is from 0.1-1.6 weight percent, based on the total weight of the first and second polymers and wherein the addition takes place under conditions such that the pH of the mixture is greater than 9.0;
3. acidifying said aqueous mixture to form a second aqueous dispersion, thereby converting any ionomers present to copolymers comprising copolymerized units of ethylene and a comonomer selected from the group consisting of methacrylic acid, acrylic acid, and mixtures thereof;
4. introducing said second aqueous dispersion to the surface of a rotating freeze roll, thereby coagulating said second aqueous dispersion to form a film or sheet comprising a mixture of said first copolymer and said second polymer, wherein the polymer blend composition comprises no more than about 1.6 wt. percent of the second polymer based on the total weight of said first and second polymers present in said polymer blend composition; and
5. removing the film or sheet from the freeze roll; and
B. forming a polychloroprene adhesive composition comprising said polymer blend composition by dissolving said polymer blend composition in an organic solvent.

11. A process of claim 10 wherein the second polymer is a polymer resin comprising copolymerized units of ethylene and a monomer selected from the group consisting of methacrylic acid, acrylic acid, and mixtures thereof.

12. A process of claim 10 wherein the second polymer is an ionomer of a polymer resin comprising copolymerized units of ethylene and a monomer selected from the group consisting of methacrylic acid, acrylic acid, and mixtures thereof.

13. A process of claim 12 wherein the monomer is acrylic acid.
